(19) United States
(12) Patent Application Publication
(10) Pub. No.: US 2009/0267877 A1
(43) Pub. Date: Oct. 29, 2009

(54) LIQUID CRYSTAL ON SILICON PANEL

(75) Inventors: Cheng-Chi Yen, Tainan County (TW); Yih-Long Tseng, Tainan County (TW); Hon-Yuan Leo, Tainan County (TW); Ju-Tien Cheng, Tainan County (TW)

Correspondence Address: J C PATENTS, 4 VENTURE, SUITE 250, IRVINE, CA, 92618, US

(73) Assignee: HIMAX DISPLAY, INC., Tainan County (TW)

(21) Appl. No.: 12/111,583

(22) Filed: Apr. 29, 2008

(51) Int. Cl. G09G 3/36

(52) U.S. Cl. 345/87

(57) ABSTRACT

The LCoS panel includes a display region, an odd and an even data drivers, and a data-line testing unit. The display region includes a plurality of pixel cells formed at each intersection of a plurality of scan lines and a plurality of data lines. The data lines include a plurality of odd data lines coupled to a plurality of first data channels of the odd data driver, and the data lines include a plurality of even data lines coupled to a plurality of second data channels of the even data driver. The odd and the even data drivers are arranged in a first side of the display region. The data-line testing unit is arranged in a second side of the display region opposite to the first side for selectively outputting a data-line testing signal corresponding to one of the data lines according to a data-line selecting signal.

### BACKGROUND OF THE INVENTION

1. Field of the Invention

The present invention relates to a liquid crystal on silicon (LCOS) panel, and more particularly, relates to a floor plan of LCOS panel.

2. Description of Related Art

Liquid crystal on silicon (LCOS) is a micro-display technology, which can produce much higher resolution images than the liquid crystal display (LCD) technology and enable the manufacture of big-screen high-definition television with high image quality at relatively low cost. FIG. 1 is a conventional floor plan of liquid crystal on silicon (LCOS) panel. Referring to FIG. 1, the LCOS panel 100 mainly includes a scan driver 110, a data driver 120, a signal processing unit 130 and a display region 140, wherein a plurality of pixel cells (not illustrated in FIG. 1) with array arrangement are disposed on the display region 140, and each of the pixel cells is coupled to one of the scan lines 111 and one of the data lines 121. The signal processing unit 130 respectively generates a scan driving signal SR and a data driving signal DR to the scan driver 110 and the data driver 120. The scan driver 110 sequentially transmits the scan driving signal SR to assert the pixel cells corresponding to each scan line 111, and the data driver 120 transmits the data driving signal DR to drive said pixel cells via the data lines 121 for displaying image.

In the LCOS panel, the driving signals may not be correctly transmitted to the pixel cells since the signal lines are wrong connected, and the driving signals may be attenuated during transmission since the signal lines have intrinsic resistances, and other factors affect the signal transmission, such as process variation. Therefore, a testing circuit is needed for testing the signal lines so as to ensuring that the LCOS panel can operate normally. The testing circuit is also useful to keep the LCOS panel product in good repair so that a well design of the testing circuit, which considers the signal transmission direction and conforms to the optimal layout, is important in the LCOS panel.

### SUMMARY OF THE INVENTION

Accordingly, the present invention provides a liquid crystal on silicon (LCOS) panel that its floor plan is easy for signal line testing and signal transmission.

An LCOS panel is provided in the present invention. The LCOS panel includes a display region, an odd data driver, an even data driver, an odd data-line testing unit and even data-line testing unit. The display region has a plurality of pixel cells formed at each intersection of a plurality of scan lines and a plurality of data lines. The data lines include a plurality of odd data lines and a plurality of even data lines alternatively arranged, and each pixel cell is coupled to one of the scan lines and one of the data lines. The odd data driver is arranged in a first side of the display region and the odd data driver has a plurality of first data channels respectively coupled to the odd data lines. The even data driver is arranged in a second side of the display region, which is opposite to the first side, and the even data driver has a plurality of second data channels respectively coupled to the even data lines. The odd data-testing unit is arranged in the second side of the display region and is coupled to the odd data lines. The odd data-testing unit selectively outputs an odd data-line testing signal corresponding to one of the odd data lines according to an odd data-line selecting signal. The even data-line testing unit is arranged in the first side of the display region and is coupled to the even data lines. The even data-line testing unit selectively outputs an even data-line testing signal corresponding to one of the even data lines according to an even data-line selecting signal.

An LCOS panel is provided in the present invention. The LCOS panel includes a display region, an odd data driver, an even data driver and a data-line testing unit. The display region includes a plurality of pixel cells formed at each intersection of a plurality of scan lines and a plurality of data lines. The data lines include a plurality of odd data lines and a plurality of even data lines alternatively arranged, and each pixel cell is coupled to one of the scan lines and one of the data lines. The odd data driver is arranged in a first side of the display region and the odd data driver has a plurality of first data channels coupled to the odd data lines respectively. The even data driver is arranged in the first side of the display region and the even data driver has a plurality of second data channels coupled to the even data lines respectively. The data-line testing unit is arrange in a second side of the display region and coupled to the data lines for selectively outputting a data-line testing signal corresponding to one of the data lines according to a data-line selecting signal, wherein the second side is opposite to the first side.

In an embodiment of the present invention, the foregoing LCOS panels further include a scan driver and a scan-line testing unit. The scan driver is arranged in a third side of the display region and the scan driver has a plurality of scan channels respectively coupled to the scan lines, wherein the third side is adjacent to the first side. The scan-line testing is arranged in a fourth side of the display region and coupled to the scan lines for selectively outputting a scan-line testing signal corresponding to one of the scan lines according to a scan-line selecting signal, wherein the fourth side is opposite to the third side.

The present invention provides the LCOS panel including the odd and even data drivers arranged in the first side and the second side of the display region respectively, wherein the second side is opposite to the first side. In consideration of signal transmission direction, the odd and even testing units are arranged in the second side and the first side of the display region respectively. The data lines are divided into two parts, i.e. the odd data lines and the even data lines, so that any one part of the data lines coupled to the corresponding data driver is routed to pass the display region and then connect to the corresponding testing unit in the floor plan.

Besides, the present invention provides the LCOS panel including both of the odd and even data drivers arranged in the first side of the display region. In consideration of signal transmission direction, the data-line testing unit is arranged in the second side of the display region, wherein the second side is opposite to the first side. One part of the data lines coupled to the corresponding data driver is routed to pass the other data driver and display region, and then connect to the data-line testing unit in the floor plan. The other part of the data lines coupled to the corresponding data driver is routed to pass the display region, and then connect to the data-line testing unit in the floor plan. The new floor plan of the LCOS panel is easy for signal line testing and has no influence on the smoothness of signal transmission.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional floor plan of liquid crystal on silicon (LCOS) panel.

FIG. 2 is a diagram of a liquid crystal on silicon panel according to an embodiment of the present invention.

FIG. 3 is a diagram of the LCOS according to another embodiment of the present invention.

FIG. 4A is a diagram of data-line testing unit according to the embodiment.

FIG. 4B is a diagram of scan-line testing unit according to the embodiment.

FIG. 5 is a diagram of the LCOS panel according to another embodiment of the present invention.

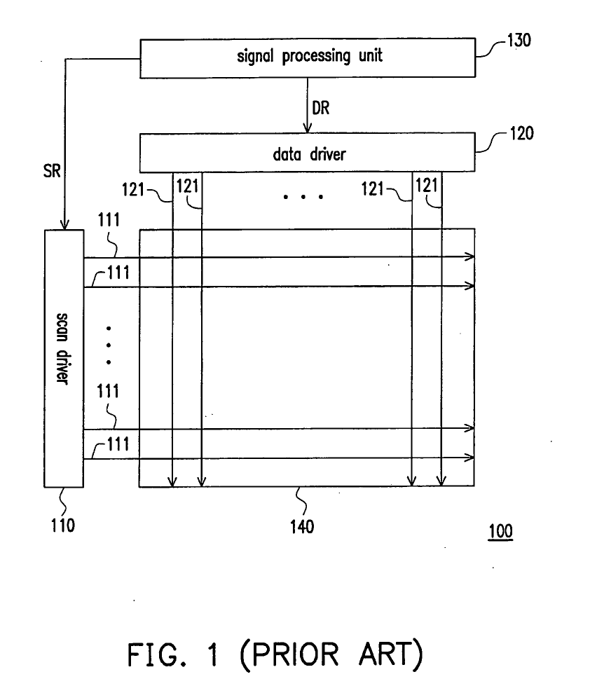

### DESCRIPTION OF EMBODIMENTS

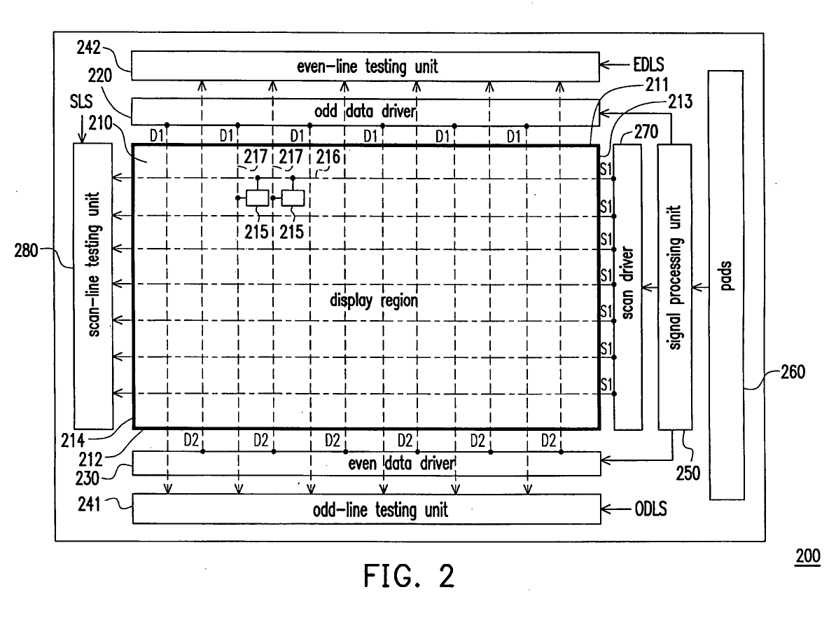

FIG. 2 is a diagram of a liquid crystal on silicon (LCOS) panel according to an embodiment of the present invention. Referring to FIG. 2, the LCOS panel 200 includes a display region 210, an odd data driver 220, an even data driver 230, an odd-line testing unit 241, an even-line testing unit 242, a signal processing unit 250, a plurality of pads 260, a scan driver 270 and a scan-line testing unit 280. The display region 210 includes a plurality of pixel cells 215 formed at each intersection of a plurality of scan lines 216 and a plurality of data lines 217, wherein each pixel cell 215 is coupled to one of the scan lines 216 and one of the data lines 217. The data lines 217 includes a plurality of odd data lines coupled to the odd data driver 220 and includes a plurality of even data lines coupled to the even data driver 230. For the convenience of description, the display region 210 has the first through fourth sides 211˜214, which each side has two adjacent sides and one opposite side.

In the embodiment, there are two data drivers provided, i.e. the odd data driver 220 and the even data driver 230, for driving data lines 217. The data lines 217 include the odd data lines and the even data lines, wherein the data lines 217 are alternately arranged with the odd data lines and the even data lines. The odd data driver 220 is arranged in the first side 211 of the display region 210, and the odd data driver 220 has a plurality of first data channels D1 respectively coupled to the odd data lines. The even data driver 230 is arranged in the second side 212 of the display region 210, and the even data driver 230 has a plurality of second data channels D2 respectively coupled to the even data lines, wherein the second side 212 is opposite to the first side 211. The scan driver 270 is arranged in the third side 213 of the display region 210, and the scan driver 270 has a plurality of scan channels S1 respectively coupled to the scan lines 216, wherein the third side 213 is adjacent to the first side 211.

The pads 260 are arranged in the third side 213 of the display region 210 and coupled to the signal processing unit 250 for electrically connecting to an external circuit. The signal processing unit 250 is also arranged in the third side 213 of the display region 210. The signal processing unit 250 provides data driving signals to the odd data driver 220 and the even data driver 230 and also provides scan driving signals to the scan driver 270. The scan driver 270 sequentially transmits the scan driving signals to the pixel cells 215 corresponding to each scan line 216. The odd data driver 220 and the even data driver 230 transmit the data driver signals to the said pixel cells 215 via the odd data lines and the even data lines respectively. The People ordinary skilled in the art have well known the operation of LCOS panel 200 for displaying an image and the detail is not to be reiterated.

In order to check whether the signal lines, i.e. the scan lines 216 and the data lines 217, are undamaged, well-connected and in good condition for signal transmission, the scan-line testing unit 280, the odd-line testing unit 241, and the even-line testing unit 242 are needed. In consideration of signal transmission direction, the odd-line testing unit 241 is arranged in the second side 212 of the display region 210 and each of the odd data lines respectively couples to the odd-line testing unit 241 across the display region 210. The odd-line testing unit 241 selectively outputs an odd data-line testing signal corresponding to one of the odd data lines according to an odd data-line selecting signal ODLS. The even-line testing unit 242 is arranged in the first side 211 of the display region 210 and each of the even data lines respectively couples to the even-line testing unit 242 across the display region 210. The even-line testing unit 242 selectively outputs an even data-line testing signal corresponding to one of the even data lines according to an even data-line selecting signal EDLS. In addition, the scan-line testing unit 280 is arranged in the fourth side 214 of the display region 210 and coupled to the scan lines 216 across the display region 214, wherein the fourth side 214 is opposite to the third side 213. The scan-line testing unit 280 selectively outputs a scan-line testing signal corresponding to one of the scan lines 216 according to a scan-line selecting signal SLS.

It is noted that, the shape of the LCOS panel 100 is often made rectangular, which has two short sides and two long sides, for adapting to visual system of human eyes. In the embodiment, the pads 260, the signal processing unit 250 and the scan driver 270 are arranged in one of the short sides, e.g. the third side 213. The odd data driver 220 and the even data driver 230 are arranged in two long sides respectively, e.g. the first side 211 and the second side 212. Nevertheless, if the pads 260 are arranged in one of the long sides, it would face to the difficulty of signal line testing and the power consumption problem produced by unsmooth signal transmission. Therefore, in order to make people ordinary skilled in the art easily practice the present invention, there is another embodiment described as follow.

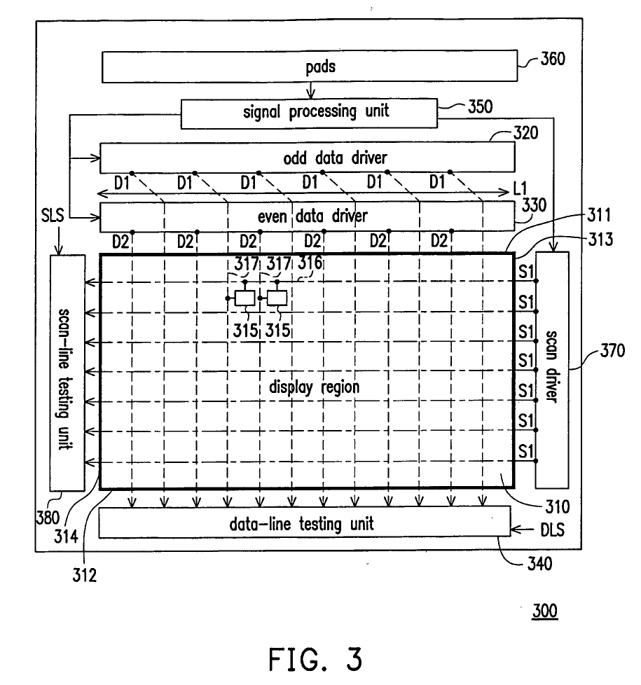

FIG. 3 is a diagram of a LCOS panel according to an embodiment of the present invention. Referring to FIG. 3, the LCOS panel 300 includes a display region 310, an odd data driver 320, an even data driver 330, a data-line testing unit 340, a signal processing unit 350, a plurality of pads 360, a scan driver 370 and a scan-line testing unit 380. For the convenience of description, the first through fourth sides 311314 of the display region 310 are shown in the FIG. 3. Referring to FIG. 2 and FIG. 3, the difference between the embodiments in FIG. 2 and FIG. 3 is that the odd data driver 320 and the even data driver 330 are arranged in the same side of the display region 310, i.e. the first side 311, and the signal processing unit 350 and the pads 360 are also arranged in the first side 311 of the display region 310. In consideration of the signal transmission direction, the data-line testing unit 340 is arranged in the second side 312 of the display region 310, wherein the second side 312 is opposite to the first side 311. The data-line testing unit 340 selectively outputs a data-line testing signal corresponding to one of the data lines 317 according to a data-line selecting signal DLS. Consequently, whether the one of the data lines 317 is in good condition or not can be tested.

Since the odd data driver 320 is arranged above the even data driver 330 in the floor plan, the odd data lines coupled to the odd data driver 320 can be routed to pass the even data driver 330 and then pass the display region 310 so as to connect with the data-line testing unit 340. In practice, the odd data lines can be formed by the metal layer different to the second channels D2 of the even data driver 330 so that the data driving signal can be transmitted via the odd data lines without affecting the operation of the even data driver 330. In addition, the even data lines coupled to the even data driver 330 can be routed to pass the display region 310 so as to connect with the data-line testing 340. This embodiment not only adds the testing units for signal line testing, but also optimizes the layout of the LCOS panel. The smoothness of signal transmission is not affected in the said embodiment and the signal line testing is easy to be performed.

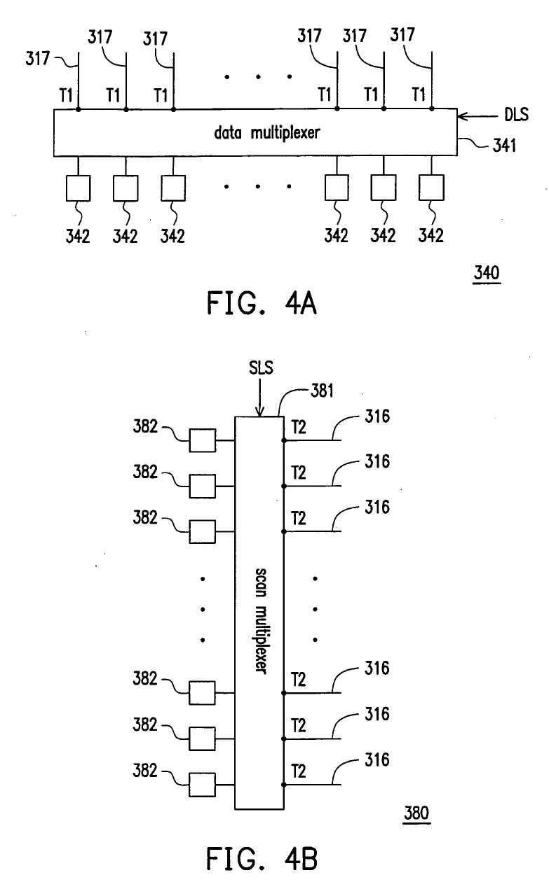

FIG. 4A is a diagram of data-line testing unit 340 according to the embodiment in FIG. 3. Referring to FIG. 4A, the data-line testing unit 340 includes a data multiplexer 341 and a plurality of data-line testing pads 342. The data multiplexer 341 includes a plurality of data-line testing channels T1 respectively coupled to the data lines 317 and selectively outputs the data-line testing signal corresponding to one of the data lines 317 according to the data-line selecting signal DLS. The data-line testing pads 342 are used for outputting the data-line testing signal. FIG. 4B is a diagram of scan-line testing unit 380 according to the embodiment in FIG. 3. Referring to FIG. 4B, the scan-line testing unit 380 includes a scan multiplexer 381 and a plurality of scan-line testing pads 382. The function of the scan-line testing unit 380 is similar to the data-line testing unit 340. The scan multiplexer 381 includes a plurality of scan-line testing channels T2 respectively coupled to the scan lines 316 and selectively outputs the scan-line testing signal corresponding to one of the scan lines 316 according to the scan-line selecting signal SLS. The scan-line testing pads 382 are used for outputting the scan-line testing signal.

It is noted that only one data-line testing unit 340 illustrated in FIG. 3 and described, but the invention should not be limited in the embodiment. Any person skilled in the art may consider the pixel cell size and the pitch between the pixel cells 315 in layout and dispose more data-line testing units in the second side 312 of the display region 310, e.g. the odd data-line testing unit for testing the odd data lines and the even data-line testing unit for testing the even data lines. The odd data-line testing unit and the even data-line testing unit described herein and described in FIG. 2 can be implemented by referring the data-line testing unit 340 in FIG. 4A. Moreover, the scan-line testing unit 280 in FIG. 2 can be implemented by referring the data-line testing unit 380 in FIG. 4B. Although the signal processing unit 350 and the pads 360 are arranged in the same side of the odd data driver 320 and the even data driver 330, i.e. the first side 311 of the display region 310, the signal processing unit 350 and the pads 360 can be arranged in the same side of the scan driver 370 in another embodiment, i.e. the third side 313 of the display region 310.

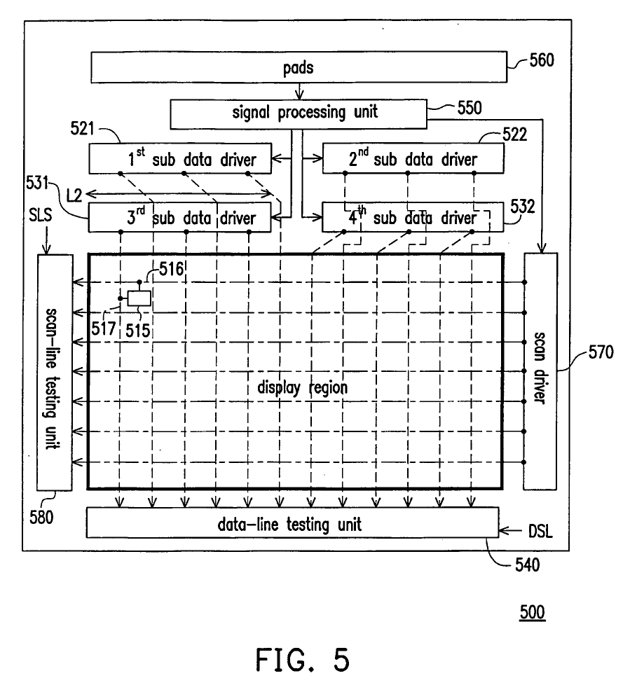

Referring to FIG. 3, the transmission path L1 of the data driving signal increases with the increase of the LCOS panel size. As known, the longer the transmission path L1 is, the more the signal propagation delay is and the lower the correctness of the data driving signal transmitted through long path is. FIG. 5 is a diagram of the LCOS panel according to another embodiment of the present invention. Referring to FIG. 3 and FIG. 5, the differences between the embodiments in FIG. 3 and FIG. 5 are that the odd data driver 520 includes a first sub data driver 521 and a second sub data driver 522, and the even data driver 530 includes a third sub data driver 531 and a fourth sub data driver 532. As the description of the embodiment in FIG. 3, the odd data driver 520 is coupled to the odd data lines and the even data driver 530 is coupled to the even data lines. The first sub data driver 521 is coupled to one part of the odd data lines and the second sub data driver 522 is coupled to the other part of the odd data lines, wherein the odd data lines are divided into the said parts according to the relative location, e.g. the left and the right. Both of the first sub data driver 521 and the second sub data driver 522 are directly connected to the signal processing unit 550 for receiving the data driving signal.

To reason by analogy, the third sub data driver 531 is coupled to one part of the even data lines and the fourth sub data driver 532 is coupled to the other part of the even data lines. Both of the third sub data driver 531 and the fourth sub data driver 532 are directly connected to the signal processing unit 550 for receiving the data driving signal. Simply speaking, the signal processing unit 550 transmits the driving signal from center to the first through fourth sub data drivers 521, 522, 531 and 532. Therefore, the transmission path L2 of the data driving signal in FIG. 5 is only half of the transmission path L1 in FIG. 3.

In summary, the said embodiments add the testing units in floor plan of the LCOS panel for signal line testing and optimize the floor plan for saving the power consumption caused by unsmooth signal transmission. The said embodiment in FIG. 2 provides the LCOS panel including the odd data driver 220 and the even data driver 230 are respectively arranged in the first side 211 and the second side 212 of the display region 210. Accordingly, the odd-line testing unit 241 and the even-line testing unit 242 are respectively arranged in the second side 212 and the first side 211 of the display region 210 in consideration of signal transmission direction. In such floor plan of the embodiment in FIG. 2, the signal processing unit 250 and the pads 260 should be arranged in the same side with the scan driver 270.

The said embodiment in FIG. 3 provides the LCOS panel including odd data driver 320 and even data driver 330 arranged in the same side of the display region 310, and the data-line testing unit 340 is arranged opposite to the said data drivers in consideration of signal transmission direction. The data lines coupled to one of the data drivers (e.g. the odd data driver 320) are routed to pass the other of the data drivers (e.g. the even data driver 330) and pass the display region 310 to conect with the data-line testing unit 340. In such floor plan of the embodiment in FIG. 3, the signal processing unit 350 and the pads 260 can be arranged in the same side of the data drivers 320 and 330 or in the same side of the scan driver 370. The floor plans of the LCOS in the said embodiments are easy for signal line testing and signal transmission. Besides, the arrangement of the pads and the signal processing unit are flexible to design the aspect ratio the LCOS panel.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A liquid crystal on silicon panel, comprising:
a display region having a plurality of pixel cells formed at each intersection of a plurality of scan lines and a plurality of data lines, wherein the data lines include a plurality of odd data lines and a plurality of even data lines alternatively arranged, and each pixel cell is coupled to one of the scan lines and one of the data lines;
an odd data driver arranged in a first side of the display region and having a plurality of first data channels respectively coupled to the odd data lines;
an even data driver arranged in the first side of the display region and having a plurality of second data channels respectively coupled to the even data lines; and
a data-line testing unit arranged in a second side of the display region opposite to the first side and coupled to the data lines for selectively outputting a data-line testing signal corresponding to one of the data lines according to a data-line selecting signal.

2. The liquid crystal on silicon panel as claimed in claim 1, further comprising:
a scan driver arranged in a third side of the display region and having a plurality of scan channels respectively coupled to the scan lines, wherein the third side is adjacent to the first side; and
a scan-line testing unit arranged in a fourth side of the display region opposite to the third side and coupled to the scan lines for selectively outputting a scan-line testing signal corresponding to one of the scan lines according to a scan-line selecting signal.

3. The liquid crystal on silicon panel as claimed in claim 2, wherein the scan-line testing unit comprises:
a scan multiplexer having a plurality of scan-line testing channels respectively coupled to the scan lines and selectively outputting the scan-line testing signal corresponding the one of the scan lines according to the scan-line selecting signal; and
a plurality of scan-line testing pads coupled to the scan multiplexer for outputting the scan-line testing signal.

4. The liquid crystal on silicon panel as claimed in claim 2, further comprising:
a signal processing unit arranged in the third side of the display region for providing a data driving signal and a scan driving signal; and
a plurality of pads arranged in the third side of the display region and coupled to the signal processing unit.

5. The liquid crystal on silicon panel as claimed in claim 1, wherein the data-line testing unit comprises:
a data multiplexer having a plurality of data-line testing channels respectively coupled to the data lines and selectively outputting the data-line testing signal corresponding to one of the data lines according to the data-line selecting signal; and
a plurality of data-line testing pads respectively coupled to the data multiplexer for outputting the data-line testing signal.

6. The liquid crystal on silicon panel as claimed in claim 1, further comprising:
a signal processing unit arranged in the first side of the display region for providing a data driving signal and a scan driving signal; and
a plurality of pads arranged in the first side of the display region and coupled to the signal processing unit.

7. The liquid crystal on silicon panel as claimed in claim 6, wherein the odd data driver comprises:
a first sub data driver coupled to one part of the odd data lines and directly connected to the signal processing unit for receiving the data driving signal; and
a second sub data driver coupled to the other part of the odd data lines and directly connected to the signal processing unit for receiving the data driving signal.

8. The liquid crystal on silicon panel as claimed in claim 7, wherein the even data driver comprises:
a third sub data driver coupled to one part of the even data lines and directly connected to the signal processing unit for receiving the data driving signal; and
a fourth sub data driver coupled to the other part of the odd data lines and directly connected to the signal processing unit for receiving the data driving signal.

9. A liquid crystal on silicon panel, comprising:
a display region having a plurality of pixel cells formed at each intersection of a plurality of scan lines and a plurality of data lines, wherein the data lines include a plurality of odd data lines and a plurality of even data lines alternatively arranged, and each pixel cell is coupled to one of the scan lines and one of the data lines;
an odd data driver arranged in a first side of the display region and having a plurality of first data channels respectively coupled to the odd data lines;
an even data driver arranged a second side of the display region opposite to the first side and having a plurality of second data channels respectively coupled to the even data lines;
an odd data-line testing unit arranged in the second side of the display region and coupled to the odd data lines for selectively outputting an odd data-line testing signal corresponding to one of the odd data lines according to an odd data-line selecting signal; and
an even data-line testing unit arranged in the first side of the display region and coupled to the even data lines for selectively outputting an even data-line testing signal corresponding to one of the even data lines according to an even data-line selecting signal.

10. The liquid crystal on silicon panel as claimed in claim 9, further comprising:
a scan driver arranged in a third side of the display region and having a plurality of scan channels respectively coupled to the scan lines, wherein the third side is adjacent to the first side; and
a scan-line testing unit arranged in a fourth side of the display region opposite to the third side and coupled to the scan lines for selectively outputting a scan-line testing signal corresponding to one of the scan lines according to a scan-line selecting signal.

11. The liquid crystal on silicon panel as claimed in claim 10, wherein the scan-line testing unit comprises:
a scan multiplexer having a plurality of scan-line testing channels respectively coupled to the scan lines and selectively outputting the scan-line testing signal corresponding the one of the scan lines according to the scan-line selecting signal; and
a plurality of scan-line testing pads coupled to the scan multiplexer for outputting the scan-line testing signal.

12. The liquid crystal on silicon panel as claimed in claim 10, further comprising:
a signal processing unit arranged in the third side of the display region for providing a data driving signal and a scan driving signal; and
a plurality of pads arranged in the third side of the display region and coupled to the signal processing unit.

13. The liquid crystal on silicon panel as claimed in claim 9, wherein the odd data-line testing unit comprises:
a data multiplexer having a plurality of data-line testing channels respectively coupled to the odd data lines and selectively outputting the odd data-line testing signal corresponding to one of the odd data lines according to the odd data-line selecting signal; and
a plurality of odd data-line testing pads respectively coupled to the data multiplexer for outputting the odd data-line testing signal.

14. The liquid crystal on silicon panel as claimed in claim 9, wherein the even data-line testing unit comprises:
a data multiplexer having a plurality of data-line testing channels respectively coupled to the even data lines and selectively outputting the even data-line testing signal corresponding to one of the even data lines according to the even data-line selecting signal; and
a plurality of even data-line testing pads respectively coupled to the data multiplexer for outputting the even data-line testing signal.
